(19) United States
(12) Patent Application Publication
(10) Pub. No.: US 2024/0118669 A1
(43) Pub. Date: Apr. 11, 2024

(54) MANAGEMENT SYSTEM FOR INFRASTRUCTURE OF AN INDUSTRIAL SYSTEM

(71) Applicants: Schneider Electric USA, Inc., Andover, MA (US); Schneider Electric Systems USA, Inc., Foxboro, MA (US)

(72) Inventors: Ling Wu, Andover, MA (US); Merrill Harriman, West Ossipee, NH (US); Sandip Mondal, Nepean-Ontario (CA)

(73) Assignees: Schneider Electric USA, Inc., Boston, MA (US); Schneider Electric Systems USA, Inc., Foxboro, MA (US)

(21) Appl. No.: 18/378,564

(22) Filed: Oct. 10, 2023

Related U.S. Application Data
(60) Provisional application No. 63/414,700, filed on Oct. 10, 2022.

(51) Int. Cl. G05B 17/02

(52) U.S. Cl. CPC G05B 17/02

(57) ABSTRACT

A system and method are provided for managing infrastructures of an industrial system. The method includes receiving a desired state that models a state of two or more of infrastructures of the industrial system, wherein the two or more infrastructures are a virtual infrastructure of the industrial system and at least one a physical infrastructure and a network infrastructure of the industrial system. The method further includes receiving a current state that models a current state of the two or more infrastructures of the industrial system, determining a difference between the desired state and the current state, and causing, as a function of the determined difference, one or more changes to the current state of the infrastructures of the industrial system, wherein determining the difference and causing the one or more changes involves the two or more infrastructures.

### CROSS REFERENCE TO RELATED APPLICATIONS

This application claims priority to U.S. Provisional Patent Application Ser. No. 63/414,700 filed Oct. 10, 2022, which is incorporated herein by reference in its entirety.

### TECHNICAL FIELD

The present disclosure relates to management of infrastructure of an industrial system, and more particularly, to increased automation of management of infrastructure of an industrial system.

### BACKGROUND

Currently, management of an infrastructure of an industrial system can include many manual processes, such as deployment of software packages, containers, and workloads on a targeted hardware or virtual component that can be included in any of a physical, virtual, or network infrastructure of the industrial system. As the system scales up, decisions for when and what to manage (e.g., to deploy, remove, replace, or update) become more complex, and implementing the decisions manually becomes more cumbersome. An update to one of the physical, virtual, or network infrastructures can cause the need for an update to a different one of the physical, virtual, or network infrastructures.

While current systems and methods have performed adequately, there is still a need in the art for a greater degree of automation in deciding what to manage and implementation of the decision. This disclosure aims to fill that need.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a computer-implemented method for managing infrastructures of an industrial system. The method includes receiving a desired state that models a state of two or more of infrastructures of the industrial system, wherein the two or more infrastructures are a virtual infrastructure of the industrial system and additionally, a physical infrastructure and/or a network infrastructure of the industrial system. The method further includes receiving a current state that models a current state of the two or more infrastructures of the industrial system, determining a difference between the desired state and the current state, and causing, as a function of the determined difference, one or more changes to the current state of the infrastructures of the industrial system, wherein determining the difference and causing the one or more changes involves the two or more infrastructures.

In one or more embodiments, the change can be determined as a function of dynamic optimization of resources of the two or more infrastructures of the industrial system.

In one or more embodiments, the causing the change can include selecting a workload, selecting or instantiating a virtual controller of the virtual infrastructure, and deploying the workload on the selected or instantiated virtual controller for causing the virtual controller to operate within the infrastructures of the industrial system.

In one or more embodiments, the infrastructures of the industrial system can include at least one virtual controller and causing the change includes at least one of deploying a workload on the virtual controller and modifying the workload deployed on the virtual controller.

In one or more embodiments, the workload can be stateful.

In one or more embodiments, the causing the change further can further include selecting a rule as a function of the difference, applying the rule, and outputting a workflow as a function of applying the rule, wherein the workflow causes the change effecting the controller.

In one or more embodiments, the receiving the current state, the determining the difference, and the causing the change can be performed automatically or semi-automatically with configurable user intervention.

In one or more embodiments, the difference can be determined as a function of a physical device being physically added to the physical infrastructure, and the causing the change can include provisioning the physical device to perform a mission associated with the physical device.

In one or more embodiments, the difference can be determined as a function of a failure of a first node included in one of the physical, virtual, or network infrastructures, wherein the first node can be originally designated as requiring high availability and a second node can operate as a redundant pair of the first node, wherein causing the change can include: upon failure of the first node, causing the second node to automatically assume a role of the first node instead of its original role and automatically assigning to a third node the original role of the second node such that the redundant pairing is automatically re-established between the second and third nodes.

In one or more embodiments, the causing the change can include optimizing operation of and/or resource usage in the physical, virtual, and/or network infrastructures.

In accordance with an additional aspect of the disclosure, a management system is provided that has one or more memories configured to store a plurality of programmable instructions, and one or more processing devices in communication with the one or more memories. The one or more processing devices, upon execution of the plurality of programmable instructions, are configured to perform the disclosed method.

In accordance with further aspects of the disclosure, a one or more non-transitory computer readable storage mediums and one or more computer programs embedded therein is provided, which when executed by a computer system, cause the computer system to perform the corresponding disclosed method.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 is a block diagram illustrating an example orchestration system for managing an industrial system infrastructure, in accordance with embodiments of the disclosure;

FIG. 2 is a block diagram of a management module of the orchestration system of FIG. 2, in accordance with embodiments of the disclosure;

FIG. 3A is a block diagram of a compute node of a virtual infrastructure of the industrial system infrastructure, in accordance with embodiments of the disclosure;

FIG. 3B is a block diagram of a physical node of a physical infrastructure of the industrial system infrastructure, in accordance with embodiments of the disclosure;

FIG. 3C is a block diagram of a network node of a network infrastructure of the industrial system infrastructure, in accordance with embodiments of the disclosure;

FIG. 3D is a schematic diagram of nodes of an industrial system infrastructure under management of a management module during an event causing a change roles for achieving high availability, in accordance with embodiments of the disclosure;

FIG. 4 is a flowchart showing an example method for managing an infrastructure of an industrial system, in accordance with embodiments of the disclosure; and

FIG. 5 is a block diagram of an exemplary processing system that could be used to implement a method for providing customized logic for orchestration of an industrial system, in accordance with embodiments of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a memory storage device or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

As used herein, the term “device” refers to hardware component before or after deployment of any applications on the hardware component.

The disclosure is directed to automation of management of an industrial system infrastructure, including deciding when to make changes and implementing the decisions. A management system is disclosed that systematically and automatically compares a current state of the industrial system infrastructure to a desired state of the industrial system infrastructure. The desired state of the industrial system infrastructure is represented by logic, which can be in the form of a system state machine, which is described in concurrently filed Patent Application entitled “PROVISION OF CUSTOMIZED LOGIC FOR ORCHESTRATION”, also assigned to Schneider Electric USA, the contents of which are incorporated in their entirety herein.

The disclosed management system enables automatic performance as a function of the comparison, based on a global view of the industrial system infrastructure, of one or more management tasks for managing multiple sub-infrastructures of the industrial system infrastructure. The management tasks include device onboarding, device provisioning, orchestration of the multiple sub-infrastructures, device discovery, device management, aggregation of real time data from the sub-infrastructures, monitoring for diagnostics of the sub-infrastructures for optimization of operation, optimization of resource usage, visualization of operation of the multiple sub-infrastructures, enablement of a “plug and produce” user experience, implementation of high availability in a stateful manner, failure recovery, and fault recovery, without limitation to these management tasks. The management tasks can be performed dynamically, based on real time data.

The sub-infrastructures include a physical infrastructure, a virtual infrastructure, and a network infrastructure. The physical infrastructure includes physical nodes that can be connected to one another. The physical nodes and relationships between the physical nodes are defined by a topology. Software and/or workloads can be deployed on the physical nodes in a nonvirtual manner. A physical node is a hardware component, and can include a combination of one or more memories, one or more processors, and firmware. Software can be stored in the memory for execution by the processor(s), also referred to as deployment.

The virtual infrastructure includes applications that define virtual nodes, such as virtual machines, containers, workloads to configure firmware of the physical nodes, clusters of containers, A virtual node can be deployed on a hardware component or on another virtual node.

The network infrastructure includes network nodes that can include dumb and/or smart network components that provide communication between any combination of physical nodes, their software, and virtual nodes. The network nodes include hardware components. The hardware components of smart network components also include one or more memories and one or more processors. Applications, including software applications or virtual nodes can be deployed on the smart network components.

The industrial system infrastructure is managed by a management system. The management system is provided with a desired state and a current state and manages the industrial system infrastructure based on differences between the desired state and current state. Each state (of the desired state and the current state) models the industrial system infrastructure by defining two or more of the physical, virtual, and network infrastructures. The state defines nodes (physical, virtual or network nodes), their configurations, and relationships between any combination of the hardware components (of the physical and/or network infrastructures) and the applications of the virtual infrastructure as well as of at least one of the physical and network infrastructures. The configuration and relationships can be represented, for example, by metadata.

The desired state defines the industrial system infrastructure in accordance with policy rules. The current state models the industrial system infrastructure based on feedback from the actual industrial system infrastructure. When there is a difference determined between the desired state and the current state, the management system causes one or more changes to the current state of the industrial system infrastructure as a function of the determined difference.

This is a state-seeking model, such that the management system causes changes to the current state of the industrial system infrastructure in order to achieve a desired state. Whenever the industrial system infrastructure veers away from a desired state, whether intentional (e.g., due to addition of a hardware component, change in policy, application upgrade) or unintentional (e.g., due to a developing problem or change in conditions), the management system causes changes to the current state in order to bring the current state to conform to the desired state.

For example, when a workload of the virtual infrastructure is moved to a different physical and/or virtual location, the network infrastructure can be changed to accommodate this move and provide new communication paths.

In another example, when a software application executing on a physical node of the physical infrastructure receives a user input to change the task of the industrial system infrastructure (e.g., produce peanut butter cookies instead of chocolate chip cookies), the virtual nodes, e.g., workloads of the virtual infrastructure of the desired state will be updated, causing the workloads of the current state to be updated.

In another example, when a physical node of the physical infrastructure is added to the current state, the desired state can be processed to include the new physical node. The desired state can be processed by an orchestration function that provides load balancing and redefines deployment of the workloads by including the newly added physical node, thus updating the virtual infrastructure of the desired state. The management system will detect the difference between the updated desired state and cause the same update to be performed in the current state.

In another example, when a physical node of the physical infrastructure of the current state is updated by upgrading a software application of the physical or network infrastructures, the desired state can be processed to include upgrade a corresponding software application. The desired state can be processed by an orchestration function that determines a policy rule is no longer satisfied or a configuration of a hardware component or application is no longer valid. The desired state can be modified to correct the noncompliance or invalidation, thus updating the physical infrastructure, virtual infrastructure, and/or network infrastructure of the desired state. The management system will detect the difference between the updated desired state and cause the same update to be performed in the current state.

The desired state and current state can each model two or more of the virtual infrastructure, physical infrastructure and/or network infrastructure. When the management system detects a difference between the desired state and the current state and causes a change, the change can involve the two or more sub-infrastructures. For example, when detecting a difference between one of the infrastructures in the desired state and current state, the management system can cause a change to occur in a different one of the infrastructures in the current state.

The desired state provides a first twin (e.g., a digital twin) of the industrial system infrastructure as desired. The current state provides a second twin of the industrial system infrastructure according to its actual condition. The first and second twins can be compared for detecting differences between them. When the management system causes a change, it can change the current state, and the one or more changes are implemented in the actual industrial system infrastructure, such as by causing deployment of a workload, an update to firmware, an update to software, a change in load balancing, an onboarding process, or a provisioning process.

Accordingly, the desired state and the current state each include a set of hardware components and a plurality of applications deployed on the hardware components in compliance with the policy rules, wherein, when in operation, when the applications are deployed on the industrial system infrastructure's hardware components and the applications are executed, the industrial system infrastructure affects an associated industrial system (e.g., by controlling, monitoring, providing communication, providing a local or cloud-based service, using a local or cloud-based service), Actions executed by the industrial system (that are controlled or monitored) of tasks include can include moving an object with a mechanical arm, filling a bottle with milk, taking a picture for image processing, etc. The industrial system can include a plurality of subsystems performing multiple tasks. The industrial system infrastructure is not limited to a cluster and/or associated hosts of the cluster. The desired state and current state of the industrial system infrastructure can model all of its hardware components and applications or a portion of them. This can include all or a portion of the hardware components and software components of any combination of the physical infrastructure, virtual infrastructure and network infrastructure. networked assets within industrial system infrastructure 101 include, but are not limited to servers, interprocess communications (IPCs), programmable logic controllers (PLCs), drives, I/O interfaces, sensors, actuators, gateways, routers, switches, etc.

The set of hardware components and the plurality of applications deployed on the hardware components can be integrated such that a change to the hardware components (such as addition of a new hardware component, misfunction or failure of a hardware component, upgrade of a hardware component) would affect other hardware components, would cause a need to change deployment of the applications, and/or would cause a need to update the policy. Furthermore, a change to an application (such as deployment of a new application on a hardware component, misfunction or failure of an application, upgrade of an application) would affect other applications, would cause a need to change deployment of the applications, would cause a need to change or upgrade a hardware component, and/or would cause a need to update the policy. In addition, a change in the policy would cause a need to upgrade or change deployment of the hardware components and/or the applications.

In addition, a change to one of the physical, virtual, or network infrastructures in one of the desired state or current state can affect a different one of the physical, virtual, or network infrastructures in the other of the desired state or current state.

The term “plug and produce” refers to a function for integrating a device into the industrial system in response to the device receiving power in order that the device can perform its functions. Plug and produce can implement any or all management tasks to automatically enable a device to produce once a user plugs it in or powers it on, including for a device that is straight out of its box. Produce means the device can perform its mission and be integrated into the industrial system.

The management system can manage respective hardware components and applications (for and following deployment) of the industrial system from a starting point of and throughout its lifecycle within the industrial system. This management can be performed with minimal or no human intervention. The amount of human intervention required or allowed can be configurable. Any user intervention can have reduced expertise requirements for the user relative to the manual tasks that are currently needed to be performed.

Security of the both the management system and the industrial system can be guarded by requiring bi-directional authentication between the devices of the industrial system and the management system.

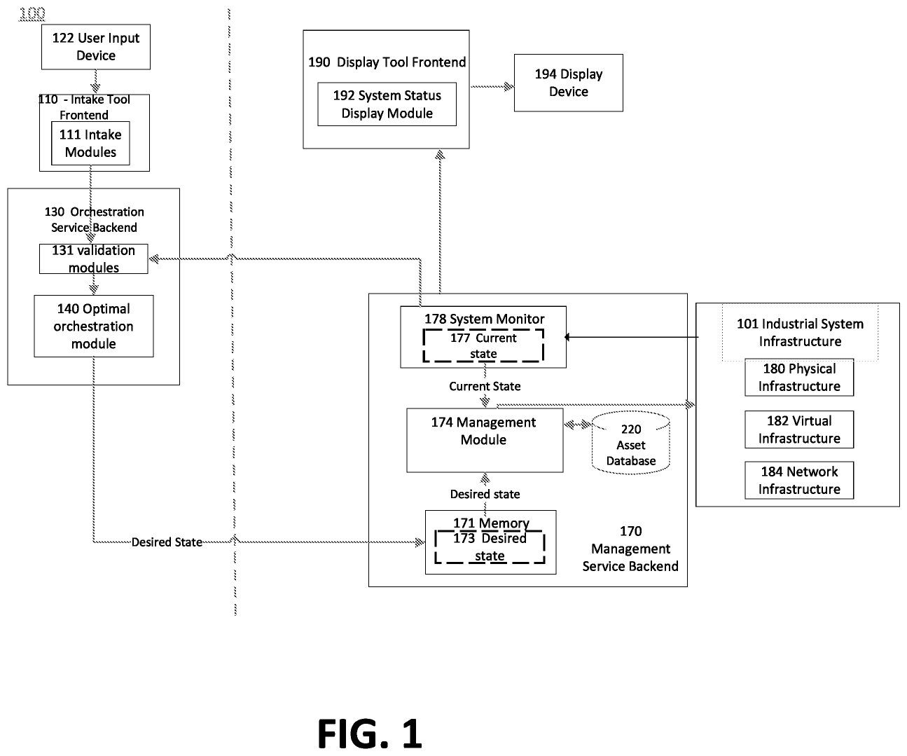

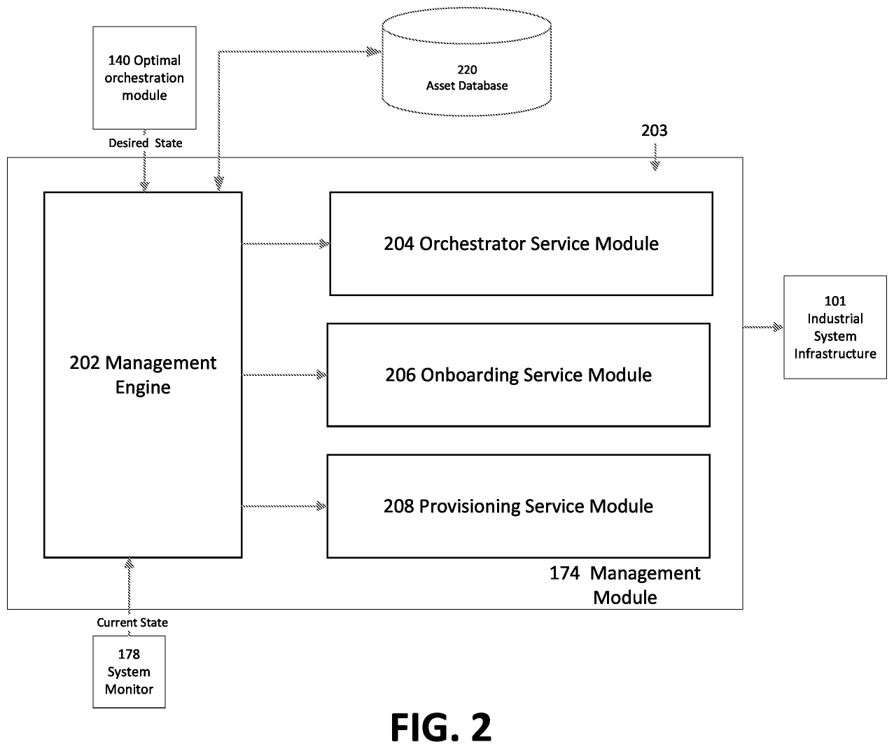

Reference will now be made to the drawings wherein like reference numerals identify similar structural features or aspects of the subject disclosure. For purposes of explanation and illustration, and not limitation, a block diagram of an exemplary embodiment of a management system for an industrial system in accordance with the disclosure is shown in FIG. 1 and is designated generally by reference character 100. Other embodiments of management system 100 in accordance with the disclosure, or aspects thereof, are provided in FIGS. 2-5, as will be described.

The following patent application and patent publications, which are assigned to Schneider Electric Industries SAS, describe aspects of presentation and updating of a topology and deployment and management of assets in an industrial system, and are each incorporated herein by reference in their entirety: U.S. Ser. No. 10/845,78662, U.S. Ser. No. 11/079,74462, U.S. Ser. No. 11/579,59562, US20210356944A1, and US20230161332A1.

Management system 100 for managing an industrial system infrastructure 101 includes an intake tool frontend 110, an orchestration service backend 130, a management service backend 170, and a display tool frontend 190. The industrial system infrastructure 101 is an infrastructure for an industrial system, such as and without limitation, a refinery system, a chemical production system, an electronics manufacturing system, a vehicle production system, etc. The industrial system infrastructure includes assets, including hardware components (physical assets) and applications (software, virtual, and/or logical assets), The industrial system infrastructure 101 includes a physical infrastructure 180 having a plurality of physical nodes (also referred to as hardware components), a virtual infrastructure 182 having a plurality of virtual nodes (also referred to as compute node(s)), and a network infrastructure 184 having a plurality of network nodes.

A portion or all of the hardware components can be on-premises, allowing industrial system infrastructure 101 to be air gapped from any networks that are not on-premises. In one or more embodiments, the hardware components can include remote hardware components. All or a portion of the hardware components can be always connected to an off-premises network, intermittently or periodically connected to the off-premises network (e.g., once per day or week), or air-gapped and never connected to the to the off-premises network.

Intake tool frontend 110 includes intake modules 111 that allow a user to build or update a topology of industrial system infrastructure 101 by entering and/or updating assets (hardware components and applications) of industrial system infrastructure 101, configuration of the assets, logical and/or physical connections between the hardware components, and policy rules.

The hardware components are physical modules that are usable by the industrial system once applications are deployed on the physical modules. The hardware components can include an operating system, or can be simple devices (e.g., —sensors, simple actuators, simple input/output (I/O) modules) that do not require an operating system. Deployment of applications on the hardware system is handled by management tasks performed by management system 100. The hardware components can be configured with applications (meaning one or more of the applications are deployed on hardware component). The configured hardware components can be included in the physical infrastructure 180 and network infrastructure 184. Some examples of hardware components include, without limitation, servers, interprocess communications (IPCs), programmable logic controllers (PLCs), drives, I/O interfaces, sensors, actuators, gateways, routers, and switches.

The applications can include software (nodes of the physical infrastructure 180 or network infrastructure 182), compute nodes of virtual infrastructure 182, such as, and without limitation, virtual controllers (e.g., virtual PLCs or distributed programmable automation controllers (DPACs). control applications (for distributed control nodes (DCNs)), virtual machines (VMs), Docker™ containers, Kubernetes™ workloads, containers, and/or container clusters, and/or web assemblies (WASM).

The policy rules define policies for industrial system infrastructure 101 and/or include optimization goals for configuration of industrial system infrastructure 101. The policies can include, for example, high availability and one or more goals of optimization. An optimization goal can include, for example, a minimum or maximum number of devices to be used and/or whether load should be evenly distributed through all the devices, implementation of a trial application away from the production environment for detection of and response to suspected cyberthreats, a requirement of user authorization before allowing orchestration to perform an action (e.g., firmware or container updates), a maximum coexistence of two applications on the same node for strategic or compatibility concerns, a limitation of functionality during certain operating modes, etc.

The optimization goal can be defined by the policy rules entered by the user using input tool frontend 100. Some examples of optimization goals include, without limitation, minimal number of devices running, minimal and even CPU consumption per device, minimal power consumption, scaling up or down for production changes, batch process changes (e.g., for producing cookies vs. cupcakes), cybersecurity hardening in the event of a suspected attack, thermal response, minimizing resource costs, etc.

Intake modules 111 can provide a user-friendly graphic user interface (GUI) that allows the customer to build the topology of industrial system infrastructure 101. The GUI can provide one or menus via which the user can make selections for creating or updating the topology. The menus can access one or more libraries. The libraries can be used to populate one or more dropdown lists. Information in the libraries can be standardized or can be converted into a standardized format used by the topology. In this way, the user-selected and configured assets are entered into the topology using the standardized format. Libraries can be provided of fully assembled hardware components, sub-components for assembling into hardware component, software programs, control applications (e.g., workloads), etc. An example of a subcomponent in a subcomponent library is a particular driver that is needed under circumstances, such as a graphics processor driver that is needed to run an AI application in a software library that could potentially be run on an IPC in a hardware library.

The user can cause this submission by selecting a designated graphical button on the GUI or the submission can be autonomous once it is confirmed that the process of building or updating the topology has been completed. Once the topology has been built or updated, it represents a desired topology of the overall (meaning global) industrial system infrastructure 101. The desired topology is submitted to orchestration service backend 130.

Orchestration service backend 130 includes validation modules 131 and optimal orchestration module 140. Validation modules 131 check validity of the individual hardware components and applications, as well as a combination of the hardware components, applications, and policy rules. Any aspect of the topology that is found to be invalid is flagged and provided to the intake tool frontend for correction of the invalidity. Once validation is complete, the desired and validated topology is provided to optimal orchestration module 140.

Optimal orchestration module 140 is configured to generate logic from the standardized topology of the overall industrial system infrastructure 101 that can be used for management of industrial system 131. The logic can be provided in the form of a system state machine, but is not limited to a specific format. The format can be compatible with modules of management service backend 170 so that the logic can be implemented. Optimal orchestration module 140 optimizes the logic by using one or more optimization algorithms. The logic represents an optimized deployment of the topology of the overall industrial system infrastructure 101, including a representation of deployment of the applications on the hardware components for the overall industrial system infrastructure 101 in compliance with the policy rules. The optimization algorithms evaluate different versions of deployment that can be derived from the topology and determine which version of the deployment has the best results for achieving one or more optimization goals. The logic that corresponds to the version of deployment that is selected to be provided to management service backend 170 as a desired state of industrial system infrastructure 101.

The optimization goal can be defined by the policy rules entered by the user using orchestration policy intake module 120. Some examples of optimization goals include minimal number of devices running, minimal and even CPU consumption per device, etc.

The desired state defines a configuration and can be expressed in software, which can be provided in a format that can be used by management service backend 170, such as a descriptive format. Some descriptive formats that could be use include JSON™, YAML™, or TOSCA™. The desired state defines and describes an optimal deployment of applications on the hardware devices, including for different states of the industrial system infrastructure 101 and optimal operation of the assets.

Explanation of operation of intake tool frontend 110 and orchestration service backend 130 is described in detail in concurrently filed nonprovisional application entitled “PROVISION OF CUSTOMIZED LOGIC FOR ORCHESTRATION,” and assigned to Schneider Electric Systems USA, which is incorporated by reference herein in its entirety.

Management service backend 170 includes memory 171, a management module 174, an asset database 176, and a system monitor 178. Management service backend 170 receives the desired state from orchestration service backend 130 and stores it as desired state 173, such as in the form of a state machine, in memory 171. Desired state 173 is accessed by or provided to management module 174. Management module 174, which is shown in greater detail in FIG. 2, can be included, for example, in a computer-integrated management system (CIMS). Management module 174 can utilize logic provided by desired state 173 to call and implement tasks.

Desired state 173 can have a format that is compatible with management module 174 and its components, which allows management module 174 and its components to use and implement the logic represented by desired state 173.

System monitor 178 monitors industrial system infrastructure 101 and outputs a current state, which is the overall state of industrial system infrastructure 101. Current state 177 can be in a format (e.g., a state machine) that is compatible with desired state 173 to enable comparison between the two.

Management module 174 can continuously or periodically compare current state 177 to desired state 173, both of which refer to a state of overall industrial system infrastructure 101. This comparison can be performed in real time. A detection of a difference between current state 177 and desired state 173 can be referred to as a detected difference event. Management module 174 can respond to the detected difference event, such as by performing one or more tasks, also referred to as an orchestration workflow. Management module 174 can also be triggered to perform these tasks by an application executing within industrial system infrastructure reporting detection of an event, such as its own state or an event external to the application. Management module 174 can apply orchestration rules that define an orchestration workflow to perform in response to a particular detected difference event or reported event,

The tasks can include, without limitation, deploying workflows on hardware components of industrial system infrastructure 101 (such as upon detection of the presence of a hardware component or virtual controller in current state 177 not included in desired state 173 and then prompting automated plug and produce), providing a higher availability by reestablishing high availability (such as upon detection of a lack of high availability in current state 177 relative to high availability provided by desired state 173); recovering from faults or failure of applications and hardware components (such as upon detecting missing or failing components in current state 177 relative to desired state 173) including the network) of industrial system infrastructure 101 detected in current state 177, provisioning and onboarding assets of industrial system 101 infrastructure once added, changes to device configuration, updates to firmware, changes to network, etc.

Some other tasks include orchestration, device management, aggregation of real time data from devices, device and network monitoring for diagnostics for optimization of operation, optimization of network resource usage, and deployment of assets.

The recipients of management and orchestration provided by management module 174 can include various hardware components and applications of industrial system infrastructure 101, such as controllers, edge devices, network switches, containers, and non-containerized software applications, Devices managed can be clustered (including managing across multiple clusters) and can be non-clustered. Devices managed can have an operating system or can have no operating system. Some examples of devices that have no operating system include, for example and without limitation, I/O interfaces, sensors, actuators, protection relays, etc.

These tasks can be performed automatically without user (meaning human) intervention or with user intervention. The amount of user intervention can be configurable. For example, a user may be prompted to give permission for an action to be performed. This allows tasks that were previously time consuming and required user expertise for performance to be performed quickly, with little or no user intervention.

The management and orchestration provided by management module 174 depends on desired state 173, which is configurable logic. Configuration of desired state 173 can be used to customize management system 100 for use with different industrial systems, for different applications of the same industrial system, and/or to change dynamically in real time. Desired state 173 can be changed at any time by changing the selected hardware components, their configuration and/or their topology; the selected applications (virtual and nonvirtual) and/or their configuration, and/or the policy rules. The policy rules can define a stateful protocol for critical workloads, such as for workload failure response, workload fault recovery, and workload high availability. Desired state 173 can be changed to accommodate far more than orchestration of scaling up or down and load balancing in a stateless computing environment.

Additionally, optimization of desired state 173 by optimal orchestration module 140 in accordance with selectable optimization goals per the policy rules provides further ability to customize management system 100 to a specific industrial system and to accommodate constraints of an Industrial system. Such industrial system constraints can include, for example, safety, cybersecurity, system disruption response, an air gapped domain, and conformance to regulatory policies.

System monitor 178 is configured to monitor industrial system infrastructure 101, including a state of its hardware components and applications and outputs a current state (e.g., a state machine) that is presented to management module 174. For example, system monitor 178 can monitor properties of industrial system infrastructure 101, such as CPU usage of each hardware component and application health status, etc. System monitor 178 can further aggregate information about monitoring results, which can be provided for further data analysis. The monitored features can be codified in current state 177 in a manner that can be compared to desired state 173.

Current state 177 and desired state 173 can be represented in a similar ontology using a language, such as TOSCA. In this way, lists of deployed containers, firmware version, CPU temperature, network interface status, application recorded response times, etc. of current state 177 and desired state 173 can be compared and a difference between current state 177 and desired state 173 can be determined.

Current state 177 and desired state 173 can each be represented as a digital twin that is a digital representation of assets of industrial system infrastructure 101. The digital twins can include asset metadata having references, for example and without limitation, to dependent artifacts, enumeration of application programming interfaces (APIs), call out services for interfacing to the asset, relationship between the assets of industrial system infrastructure 101, asset instance policy information, and asset specific orchestration workflows.

In a situation in which system monitor detects, that a problem has arisen in industrial system infrastructure 101, such as overload of a hardware component or an application, an elevated temperature of a hardware component, etc., this information can be provided to input validation module 131 in orchestration service backend 130. For example, an orchestration rule can define a temperature operating range. When the rule is violated an orchestration workflow associated to the orchestration rule can be initiated that would reconcile the temperature issue.

Input validation module 131 can repeat cross input validation to cause an adjustment to one or more assets or policy rules of the topology of the industrial system infrastructure 101. Examples of some adjustments include moving an application from one hardware component to another hardware component or removing a hardware component that had an elevated temperature. In one or more embodiments, the adjustment can be automatic (e.g., can be driven by an optimization policy rule) or can include user intervention. Varying degrees of user intervention can be used, such as prompting a user to perform the adjustment or recommending an adjustment contingent upon user approval. The degree of user intervention needed or allowed can be configurable. Once input validation module 138 validates the modified topology, the modified topology can be submitted to optimal orchestration module 140 so that new logic can be provided to deployment service backend 170.

System monitor 178 can further report real time information about status of industrial system infrastructure 101 to display tool frontend 190.

Display tool frontend 190 outputs the information received from system monitor 178 to a display device 192, thus providing a real time view of the status of the industrial system. A user can view the system status information of a user interface of display device 192. The user can view the displayed information on a display device 192 of a mobile device or a fixed computer.

The user can receive alarms via display device 192 when system monitor 178 detects a problem, such as a compromised hardware component or software errors. The display device can also indicate when the when the problem is resolved and the alarm is cleared, e.g., by repeating the validation process and optimization process performed by orchestration services backend 130. The display device can also indicate to the user when the problem needs manual support, such as when a hardware component has lost power and needs to be reconnected, there is high frequency of false alarms, or detected errors indicate the need for an upgrade.

Management module 174 can detect changes to current state 177 by comparing it to desired state 173. Some example, nonlimiting changes that can be detected by this comparison include addition, removal of, or upgrade of a hardware component or application. For example, management module 174 can detect that: a hardware component was added to industrial system infrastructure 101 when a hardware component that had lost power is reconnected to power, a number of hardware components was scaled up or down, and a hardware component was removed.

Management module 174 can also detect differences between current state 177 and desired state 173, which would trigger a workflow to be performed. Desired state 173 can be conceives as the single source of truth for certain conditions, such as OS version. An OS upgrade would be performed at desired state 173 by declaring a new version of an OS for an associated hardware component in the desired state. The inequality between the OS for the hardware component in current state 177 and desired state 173 would be detected and would trigger an appropriate workflow to update the OS on each instance of the hardware component.

In response to detecting a change to industrial system infrastructure 101, management module 174 can alert input validation module 138 about the change. Input validation module 138 will then prompt the user to update the topology via intake tool frontend 110. The validation process is then repeated by validation modules 131, thus validating the updated topology. After its validation, the updated topology is processed by optimal orchestration module 140 to update the logic. The updated logic is provided to management services backend 170. The updated logic can be provided to management engine 176 to update the deployment.

Intake tool frontend 110, orchestration service backend 130, management service backend 170, and display tool frontend 190 are configurable to adapt to different types of industries and businesses. Orchestration service backend 130 can be configured with different types of management and monitoring services to reflect various industries, such as proprietary or newly developed device management and monitoring protocols, cluster or node proxy services (e.g., virtual kubelets. WASM), proprietary or newly discovered cybersecurity connections, etc. Configurations can include configuration of the libraries used by intake modules 111, configuration of validation rules used by validation modules 131, configuration of rules applied by management module 174 for management and orchestration, and proprietary or newly derived optimization goals. Different business owners can configure and use intake tool frontend 110 orchestration service backend 130, management service backend 170, and display tool frontend 190 to manage and adjust (e.g., scale or update) industrial system infrastructure 101.

FIG. 2 shows management module 174 in greater detail. Management module 174 includes management module 202 and example implementation modules 203. The example implementation models 203 shown include orchestrator service module 204, onboarding service module 206, and provisioning service module 208. Different use cases can use other implementation modules 203, therefore the disclosure is not limited to the example implementation modules 203 shown. Management module 202 receives and compares current state 177 and desired state 173. Based on results of the comparison management module 202 sends a request to one or more implementation modules 203 to implement a task of a workflow.

Orchestrator service module 204 can include an orchestration tool, such as Kubernetes™, Ansible™, K3s™, WASM, a proprietary tool, etc. for implementing deployment tasks.

Provisioning service module 208 can enroll a device (e.g., a hardware component) and then perform software installation, configuration, and updates as necessary to bring the device to a state where it is considered a ready device in the system.

Then notion of enrollment is the establishment of trust with the device to validate genuineness, ownership, and authorization.

For a compute device, after enrollment it may require an OS installation or update, device services installation, driver updates, and workload management services to be installed. The provisioning actions are idempotent—they can start with a device in any state along a chain and always commence with a device at the same level of functionality. When complete, the device would be considered a “node” in the system or cluster.

For non-compute devices (drives, I/O interfaces, etc.) provisioning would involve enrollment and firmware installation as well as potentially library installations for services and drivers and any associated licensing certificates. When complete, the device would be considered a resource in the system.

Onboarding service module 206 performs onboarding after provisioning is performed. Onboarding involves loading the device with its associated configurations, workloads, and workload configurations commensurate with its role as defined in the desired state of the system model being used.

In one example use case which is for plug-and-produce, the comparison indicates that current state 177 includes a hardware component A that is not included in desired state 173, and indicates that a new hardware component A has been connected and/or powered on in industrial system infrastructure 101. When this condition occurs, a determination is made whether the hardware component A is expected and trusted. Once trust is established, the system can leverage plug and produce orchestration to bring hardware component A from a blank unconfigured state (or wrongly configured state in a case of reuse of a previously used and removed device) to a state of operation.

In one or more embodiments, a corresponding hardware component B has already been added via intake tool frontend 110, including with predeclared device level configurations (drivers, network interface configurations, etc.). The configuration can be validated by validation tools 131. Any workloads intended to be deployed explicitly deployed on hardware component A are also added and configured via intake tool frontend 110 and validated by validation tools 131. The configurations can include, for example workload configurations including cybersecurity certificates, license certificates, etc. and external configurations including VLAN memberships, routing updates, firewall configurations, etc. The explicitly assigned workload can be added to desired state 173 for deployment on hardware component B. When workloads are not explicitly assigned to hardware component B, workloads can be selected to be added to desired state 173 for deployment on hardware component B by optimal orchestration module 140 using an optimization function). The updated desired state 173 is provided to management module 164.

In one or more embodiments, if the corresponding hardware component and/or workloads were not properly added or validated. A prompt can be sent to the user to provide intervention for updating desired state 173. Management module 174 can detect a difference between the deployment configured for hardware component B of desired state 173 and blank hardware component A of current state 177. Thus, the detected difference invokes orchestrator service module 204 to perform a deployment task that includes deploying of the workloads as configured for hardware component B on the new, blank hardware component A.

In summary, predeclared device level configurations (drivers, network interface configurations, etc.) can be first deployed and validated. Then any assigned workload can be deployed (either explicitly assigned or assigned via the results of an optimization function). In addition, any workload configurations, cybersecurity certificates, license certificates, etc. can be deployed. Also, any associated external configurations can be enacted (e.g., VLAN memberships, routing updates, firewall configurations, etc.).

Unless deployments are explicitly provided by a user, desired state 173 defines the deployment of applications in accordance with the policy rules that were input via intake tool frontend 110 and the desired state 173 was validated as well as optimized by optimization service backend 130, the implementation of the deployments defined by orchestrator service module 204 is in accordance with the validated and optimized policy rules. Similarly, implementations performed by implementation models 203 can be in accordance with the validated and optimized policy rules.

Although in the example hardware component A was destined to be configured to operate with a dynamic workload, hardware component A have been a drive that only needed a proper configuration file. The plug-and-produce process would allow the configuration to be added to desired state 173 and then configured on hardware component B in current state 177. Instead of hardware component B, the newly added asset could have been a virtual node or a network node. In other examples, the application to be deployed could be a reprogramming of firmware of the hardware component, a software program, etc.

In another use example which is for implementation of high availability, given a first controller and a second controller configured as a redundant pair with one as the role of primary and the other as the role of secondary, when one controller has a fault, the other controller assumes (or maintains) the role of primary. This controller is now running as a sole controller without redundancy. Desired state 173 is defined to maintain a redundant pair; therefore, the management module 174 directs a new instance of a controller to be created and assigned the role of the first controller. Thereby it is paired with the second controller to resume the redundancy.

In another use example, a firmware update is required on a device in industrial system infrastructure 101. Via user input device 122, a user updates a firmware version of the digital twin representation of the device in the desired state. This causes a difference between the firmware versions of digital twin representations of current state 177 and desired state 173. Management module 174 detects this difference and launches a task to update firmware of the corresponding device in industrial system infrastructure 101. Once updated, desired state 173 equals current state 177.

In another use example, due to a change in the system desired state for optimized power consumption, changes in production levels, response to cyber threats, or any other reason, optimal orchestration module 140 deems that virtual workloads are to be consolidated to a reduced number of compute nodes to allow shutdown of some hardware components. This change necessitates a change in the network infrastructure to allow communication to continue for the consolidated workloads. Optimal orchestration module 140 also directs desired state 173 to enact a new network infrastructure configuration to facilitate the optimal change.

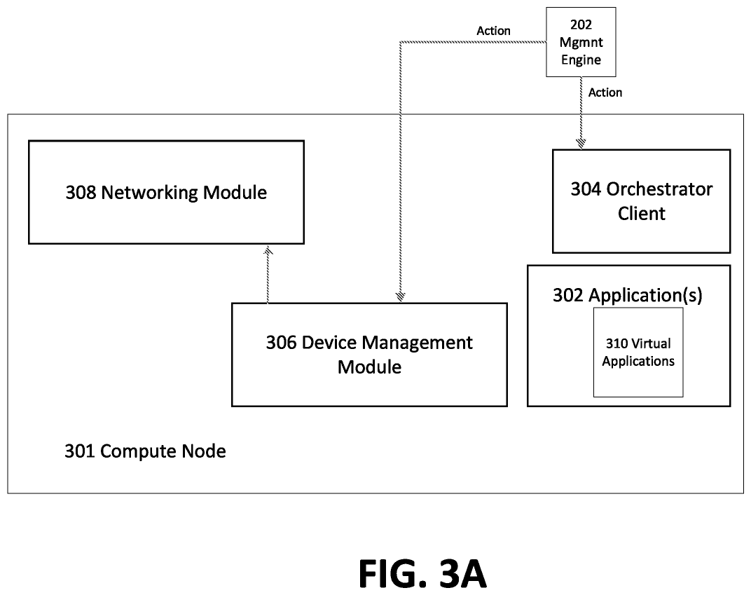

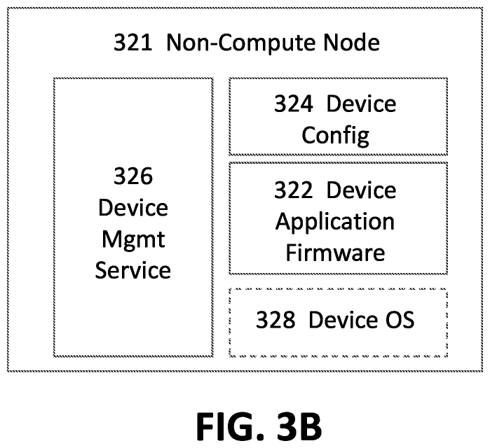

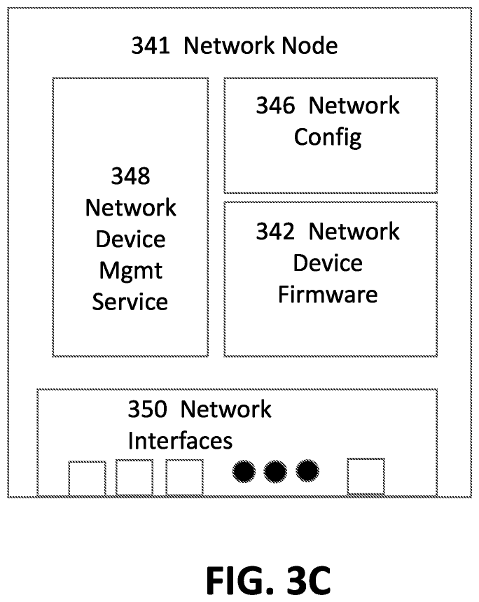

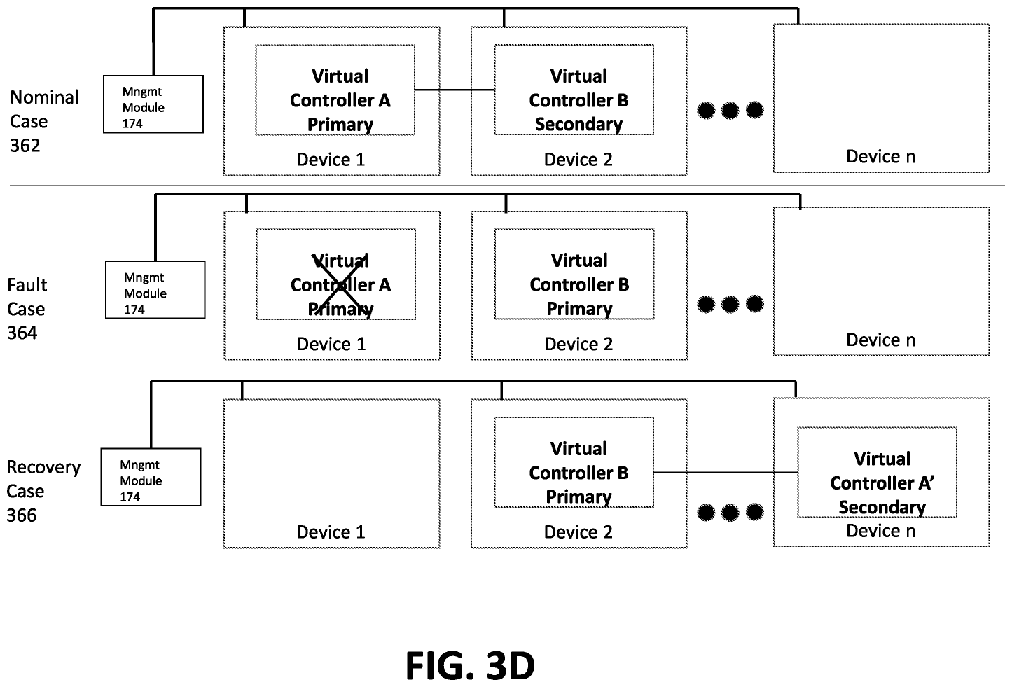

FIG. 3A shows and example compute node in detail. Compute node 301 includes a set of one or more virtual applications 302 that have been deployed on the compute node 301. Deployment of a given virtual application 310 is affected by management engine 202 directing orchestration client 304 to create and potentially configure the virtual application 310 on behalf of management engine 202. Similarly, management engine 202 can direct device management module 306 to affect changes on compute node 301 to support the virtual application 310, update software on compute node 301, or change networking configurations of the compute node 301.

With reference to FIG. 3B, a non-compute node 321 is a device with a dedicated purpose (e.g., a PLC, motor drive, gateway, etc.) that does not allow dynamic workloads to be deployed to the device. It is comprised of a device application firmware 322, a device configuration 324, a device management service 326, and optionally a device OS 328, as well as potentially other services and capabilities. Device application firmware 322 executes dedicate purpose logic that provides non-compute node 321 with its dedicated purpose. Device configuration 324 provides instance configuration information (e.g., PLC program logic, motor output tuning, addressing, etc.). Non-compute node 321 may or may not include a device OS 328 depending on the device requirements and capabilities. Device management service 326 provides a method of remotely managing the device lifecycle.

With reference to FIG. 3C, a network node 341 is a device that provides network connectivity and network traffic forwarding. Network node 341 includes a network device firmware 342, a network configuration 346, a set of network interfaces 350, and a network device management service 348. Network configuration 346 configures the network node's traffic forwarding rules between the network interfaces, including, but not limited to, Vlan memberships, traffic shaping, prioritization, etc. Network device management service 348 provides a method of remotely managing network node 341's lifecycle.

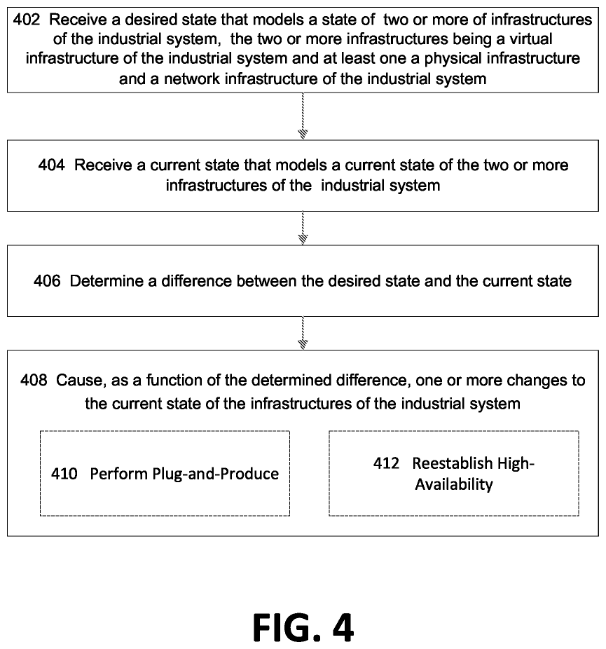

With reference now to FIG. 4, shown is a flowchart demonstrating implementation of the various exemplary embodiments. It is noted that the order of operations shown in FIG. 4 is not required, so in principle, the various operations may be performed out of the illustrated order. Also, certain operations may be skipped, different operations may be added or substituted, some operations may be performed in parallel instead of strictly sequentially, or selected operations or groups of operations may be performed in a separate application following the embodiments described herein.

Beginning with block 402, the method includes receiving a desired state that models a state of two or more of infrastructures of the industrial system. The two or more infrastructures include a virtual infrastructure of the industrial system and in addition, a physical infrastructure and/or a network infrastructure of the industrial system. At block 404, the method includes receiving a current state that models a current state of the two or more infrastructures of the industrial system.

At block 406, the method includes determining a difference between the desired state and the current state. At block 408 the method includes causing, as a function of the determined difference, one or more changes to the current state of the infrastructures of the industrial system. Determining the difference and causing the one or more changes involves the two or more infrastructures.

In one or more embodiments, the one or more changes that were caused can be determined as a function of dynamic optimization of resources of the two or more infrastructures of the industrial system.

In one or more embodiments causing the change includes selecting a workload, selecting or instantiating a virtual controller of the virtual infrastructure, and deploying the workload on the selected or instantiated virtual controller for causing the virtual controller to operate within the infrastructures of the industrial system.

In one or more embodiments, the infrastructures of the industrial system include at least one virtual controller and causing the change includes at least one of deploying a workload on the virtual controller and modifying the workload deployed on the virtual controller.

In one or more embodiments, the workload is stateful.

In one or more embodiments the causing the change further comprises selecting a rule as a function of the difference, applying the rule, outputting a workflow as a function of applying the rule, wherein the workflow causes the change effecting the controller.

In one or more embodiments, the receiving the current state, the determining the difference, and the causing the change are performed automatically or semi-automatically with configurable user intervention.

In one or more embodiments, at block 410, implementation of a plug and produce process can be performed as being included in block 408 for causing one or more functions. Plug and produce can be triggered when the difference is determined as a function of a physical device being physically added to the physical infrastructure as an unconfigured or misconfigured device. Causing the change can include provisioning the physical device to perform a mission associated with the physical device. Determining the difference includes detecting that the unconfigured or misconfigured device has a counterpart configured device that is included in the desired state. The misconfigured or unconfigured device can be onboarded and/or provisioned so that it has the same applications and configurations as its counterpart configured device in the desired state. In this way, once onboarded and/or configured, the device can perform its mission.

In one or more embodiments, at block 412, implementation of high availability is performed as being included in block 408 for causing one or more functions. A non-limiting example is shown with reference to FIG. 3D, in the Nominal Case (362) a first device (Device 1) is hosting a Virtual Controller A (VC-A), and a second device (Device 2) is hosting a Virtual Controller B (VC-B). These two controllers, as defined by their roles in desired state (such as desired state 173 shown in FIG. 1), form a redundant pair with roles of primary and secondary, respectively. Some other device (Device n) is available in the system as a spare. In the Fault Case (364), for whatever reason, VC-A, its host Device 1, or an associated network connection, fails. Upon failure of VC-A, or its associated equipment, VC-B is caused to automatically assume the role of VC-A as primary instead of its original role of secondary. The difference can be detected by management module 174 as a difference between the desired state and a current state (such as current state 177 shown in FIG. 1) in any of Device 1, VC-A, the associated network connection, or the change of role in VC-B. As show in Recovery Case 366, management module 174 directs a third node, Device n, to instantiate a replacement Virtual Controller A′ and configures it such that it assumes the original role of the VC-B as a secondary. Management module 174 may also update associated network devices to enable the pairing communication between VC-B and VC-A′. Now the redundant paring is reestablished between the VC-B and VC-A′; consequently, high availability has been automatically reestablished as well.

In one or more embodiments, causing the change optimizes operation of and/or resource usage in the physical, virtual, and/or network infrastructures.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

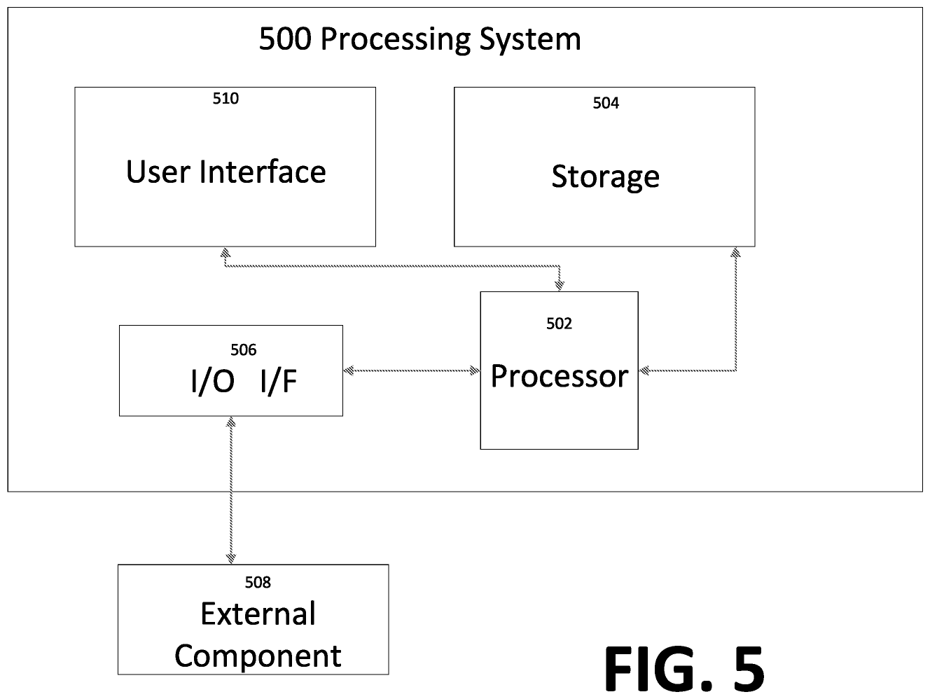

With reference to FIG. 5, a block diagram of an example processing system 500 is shown, which provides an example configuration of one or more computing systems used by computing components of a management system (such as management system 100 shown in FIG. 1 and its components). One such processing system 500 is illustrated in FIG. 5. In various embodiments, processing system 500 may be a server, a mainframe computer system, a workstation, a network computer, a desktop computer, a laptop, a handheld computer, or the like, and/or include one or more of a field-programmable gate array (FPGA), application specific integrated circuit (ASIC), microcontroller, microprocessor, or the like. Processing system 500 is only one example of a suitable system and is not intended to suggest any limitation as to the scope of use or functionality of embodiments of the disclosure described herein. Processing system 500 can be implemented using hardware, software, and/or firmware. Regardless, processing system 800 is capable of being implemented and/or performing functionality as set forth in the disclosure.

Additionally, all or portions of the computing components of the orchestration system could be configured as software, and processing system 500 could represent such portions. Processing system 500 is only one example of a suitable system and is not intended to suggest any limitation as to the scope of use or functionality of embodiments of the disclosure described herein. Processing system 500 can be implemented using hardware, software, and/or firmware. Regardless, processing system 500 is capable of being implemented and/or performing functionality as set forth in the disclosure.

Processing system 500 is shown in the form of a general-purpose computing device. Processing system 500 includes a processor 502, storage 504, an input/output (I/O) interface (I/F) 506 that can communicate with an internal component, such as a user interface 510, and optionally one or more external components 508, such as another processing device of the management system 100 or a processing device of an industrial system, such as industrial system infrastructure 101 shown in FIG. 1.

The processor 502 can include, for example, a CPU, a programmable logic device (PLD), microprocessor, a discrete signal processor (DSP), a microcontroller, a field programmable gate array (FPGA), an application specific integrated circuit (ASIC), and/or other discrete or integrated logic circuitry having similar processing capabilities. The processor 502 and the storage 504 can be included in components provided in the FPGA, ASIC, microcontroller, or microprocessor, for example.

Storage 504 can include, for example, volatile and non-volatile memory for storing data temporarily or long term, and for storing programmable instructions executable by the processor 502. Storage 504 can be a removable (e.g., portable) memory for storage of program instructions. I/O I/F 506 can include an interface and/or conductors to couple to the one or more internal components, such as user interface 510 and/or external component(s) 508.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the block diagram block or blocks.

Embodiments of the processing components of the orchestration system may be implemented or executed by one or more computer systems, such as a microprocessor. One processing system 500, or multiple instances thereof, can be included within modules of the orchestration system. In various embodiments, processing system 500 may include one or more of a microprocessor, an FPGA, application specific integrated circuit (ASIC), microcontroller. The processing system 500 can be provided as an embedded device. Portions of the processing system 500 can be provided externally, such by way of a virtual, centralized, and/or cloud-based computer.

Processing system 500 is only one example of a suitable system and is not intended to suggest any limitation as to the scope of use or functionality of embodiments of the disclosure described herein. Regardless, processing system 500 is capable of being implemented and/or performing any of the functionality set forth hereinabove.

Processing system 500 may be described in the general context of computer system-executable instructions, such as program modules, being executed by a computer system. Generally, program modules may include routines, programs, objects, components, logic, data structures, and so on that perform particular tasks or implement particular abstract data types.

The management system can use and leverage potential benefits of virtualization and clustering technologies by using orchestration tools, such as Docker, Kubernetes™, WASM, etc. that use such technologies. Other potential benefits include optimal dispatchment (independent of hardware) of workload and other applications, reliable operation and enhanced resiliency of industrial system infrastructure 101 by automatic adjustments responsive to changes in the current system state or the desired system state. A further potential advantage includes application of advanced information technology (IT) to industrial system infrastructure 101 (which has an operational technology (OT) environment) without the need for users of the industrial system having IT expertise.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method for managing infrastructures of an industrial system, the method comprising:
receiving a desired state that models a state of two or more of infrastructures of the industrial system, the two or more infrastructures being a virtual infrastructure of the industrial system and additionally, a physical infrastructure and/or a network infrastructure of the industrial system;
receiving a current state that models a current state of the two or more infrastructures of the industrial system;
determining a difference between the desired state and the current state; and
causing, as a function of the determined difference, one or more changes to the current state of the infrastructures of the industrial system, wherein determining the difference and causing the one or more changes involves the two or more infrastructures.

2. The method of claim 1, wherein the one or more changes are determined as a function of dynamic optimization of resources of the two or more infrastructures of the industrial system.

3. The method of claim 1, wherein the causing the change comprises:
selecting a workload;
selecting or instantiating a virtual controller of the virtual infrastructure; and
deploying the workload on the selected or instantiated virtual controller for causing the virtual controller to operate within the infrastructures of the industrial system.

4. The method of claim 1, wherein the infrastructures of the industrial system include at least one virtual controller and causing the change includes at least one of deploying a workload on the virtual controller and modifying the workload deployed on the virtual controller.

5. The method of claim 4, wherein the workload is stateful.

6. The method of claim 1, wherein the causing the change further comprises selecting a rule as a function of the difference, applying the rule, outputting a workflow as a function of applying the rule, wherein the workflow causes the change effecting the controller.

7. The method of claim 1, wherein the receiving the current state, the determining the difference, and the causing the change are performed automatically or semi-automatically with configurable user intervention.

8. The method of claim 1, wherein the difference is determined as a function of a physical device being physically added to the physical infrastructure as an unconfigured or misconfigured device, and the causing the change includes provisioning the physical device to perform a mission associated with the physical device.

9. The method of claim 1, wherein the difference is determined as a function of a failure of a first node included in one of the physical, virtual, or network infrastructures, wherein the first node is originally designated as requiring high availability and a second node operates as a redundant pair of the first node, wherein causing the change includes:
upon failure of the first node, causing the second node to automatically assume a role of the first node instead of its original role; and
automatically assigning to a third node the original role of the second node such that the redundant pairing is automatically re-established between the second and third nodes.

10. The method of claim 1, wherein the causing the change includes optimizing operation of and/or resource usage in the physical, virtual, and/or network infrastructures.

11. A management system for managing infrastructures of an industrial system, the management system comprising:
one or more memories configured to store a plurality of programmable instructions; and
one or more processing device in communication with the one or more memories, wherein the one or more processing devices, upon execution of the plurality of programmable instructions is configured to:
receive a desired state that models a state of two or more of infrastructures of the industrial system, the two or more infrastructures being a virtual infrastructure of the industrial system and additionally a physical infrastructure and/or a network infrastructure of the industrial system;
receive a current state that models a current state of the two or more infrastructures of the industrial system;
determine a difference between the desired state and the current state; and
cause, as a function of the determined difference, one or more changes to the current state of the infrastructures of the industrial system, wherein determining the difference and causing the one or more changes involves the two or more infrastructures.

12. The management system of claim 11, wherein the one or more changes are determined as a function of dynamic optimization of resources of the two or more infrastructures of the industrial system.

13. The management system of claim 11, wherein the causing the change comprises:
selecting a workload;
selecting or instantiating a virtual controller of the virtual infrastructure; and
deploying the workload on the selected or instantiated virtual controller for causing the virtual controller to operate within the infrastructures of the industrial system.

14. The management system of claim 11, wherein the infrastructures of the industrial system include at least one virtual controller and causing the change includes at least one of deploying a workload on the virtual controller and modifying the workload deployed on the virtual controller.

15. The management system of claim 14, wherein the workload is stateful.

16. The management system of claim 11, wherein the causing the change further comprises selecting a rule as a function of the difference, applying the rule, outputting a workflow as a function of applying the rule, wherein the workflow causes the change effecting the controller.

17. The management system of claim 11, wherein the receiving the current state, the determining the difference, and the causing the change are performed automatically or semi-automatically with configurable user intervention.

18. The management system of claim 11, wherein the difference is determined as a function of a physical device being physically added to the physical infrastructure as an unconfigured or misconfigured device, and the causing the change includes provisioning the physical device to perform a mission associated with the physical device.

19. The management system of claim 11, wherein the difference is determined as a function of a failure of a first node included in one of the physical, virtual, or network infrastructures, wherein the first node is originally designated as requiring high availability and a second node operates as a redundant pair of the first node, wherein causing the change includes
upon failure of the first node, causing the second node to automatically assume a role of the first node instead of its original role; and
automatically assigning to a third node the original role of the second node such that the redundant pairing is automatically re-established between the second and third nodes.

20. The management system of claim 11, wherein the causing the change optimizing operation of and/or resource usage in the physical, virtual, and/or network infrastructures.
